(19) United States
(12) Patent Application Publication
(10) Pub. No.: US 2026/0078744 A1
(43) Pub. Date: Mar. 19, 2026

(54) WIND TURBINE BLADE ROOT REPLACEMENT METHOD

(71) Applicant: James Rojas Waterhouse, Sao Carlos (BR)

(72) Inventor: James Rojas Waterhouse, Sao Carlos (BR)

(21) Appl. No.: 19/060,708

(22) Filed: Feb. 23, 2025

(30) Foreign Application Priority Data
Feb. 28, 2024 (BR) 1020240039440

(51) Int. Cl. F03D 80/50; F03D 1/06

(52) U.S. Cl. CPC F03D 80/502; F03D 1/0675; F05B 2230/80; F05B 2240/30; F05B 2250/192; F05B 2280/6003

(57) ABSTRACT

A method of replacing the root part from a wind turbine blade by attaching a new fabricated root part consisting of utilizing a new root part manufactured specifically for the blade to be repaired, which does not use the same materials as the original. To separate the original root segment from the original blade the cut line with single or double bevels is prepared, both in the new, pre-fabricated root assembly and in the region to be cut of the original blade. The next step is joining the new root assembly with the original blade using layers of structural fiber fabric, initially utilizing reconstruction layers and subsequently with internal and external reinforcement layers on the blade and, optionally, apply resin preferably through vacuum infusion and optionally through hand layup, to complete the joint between the new root and the original blade.

### FIELD OF THE INVENTION

The present invention describes a method of repairing a wind turbine blade, specifically about the replacement method of wind turbine blades and blades manufactured or repaired by applying the described method.

### BACKGROUND OF THE INVENTION

Wind energy, as is widely known, involves converting the kinetic energy of the wind into electrical energy. As an intermediate step, kinetic energy is transformed into rotational mechanical energy through the wind turbine rotor, which consists of one or more blades. These blades utilize airfoil aerodynamic principles like airplane wings, converting the horizontal wind movement in the atmosphere into torque that drives the electric generator.

For a wind turbine blade to be efficient, they must be made of materials that ensure structural integrity throughout its entire lifespan while also contributing to weight reduction and cost savings. Therefore, these must be lightweight and durable. Composite materials dominate this niche and are widely used in the most commercially available blades.

The wind turbine blade is exposed to various types of loads during its service life, from transportation and handling to, finally, in its full operation. Due to its interface with the hub, the root region of the blade must withstand the most demanding forces. It must be capable of fully transmitting the rotational motion of the rotor to the turbine shaft, passing through the fasteners that connect the blade to the pitch bearing and through the hub structure itself, which is directly coupled to the low-speed shaft.

Once subjected to high intensity loads, the root of the blade is always susceptible to damage, both in ultimate cases and fatigue scenarios. Therefore, the blades must be constantly monitored by an appropriate maintenance program capable of preventing and repairing potential failures before its propagation become catastrophic. Despite the design philosophy employed in a blade's conception aiming for a safe lifespan (where significant damage is not expected during the structure's useful life), errors in design, low manufacturing quality, or unforeseen mechanical stresses can lead to failures that, at the blade root, may be catastrophic for the entire component. Such situations require prompt action and remediation.

It is common that repairs at the root assembly of wind turbine blades are performed in a localized manner, focusing on a limited region of where the damage has occurred. Most of the issues observed at the connection between the blade end and the hub are related to the bushings, which are components bonded into the root and anchor the blade attachment bolts to the pitch bearing. Detachment of these inserts can lead to severe accidents, resulting in complete disconnection of the blade from the hub. Similarly, another type of attachment involves radial holes housing special nuts for securing bolts, and failures associated with these radial holes are common which often condemn the entire blade.

Damage observed in the inserts, or the housing of the bolt nuts is typically corrected by exclusively replacing these components but limited auxiliary repairs may be performed around the area where these pieces are fitted into the assembly. Common practice includes removing the inserts, cleaning the affected region, and re-bonding the inserts to the pitch bearing. In the case of bolts with special nuts, additional reinforcements may be added. These approaches do not solve the main cause of failure as it may not be limited to a single root fastener. Therefore, with a large number of damaged inserts or nut housings, the solution of replacing them one by one may be unfeasible, both from a technical and a financial perspective. This process is widely known to only increase repair costs while increasing the maintenance program without actually solving the cause. U.S. Pat. No. 8,186,960B2 is an example of a method that suggests localized repairs by removing the bolts and replacing them with bar elements bonded to the root to strengthen it, without the need to remove the blade from the hub. Despite proposing cost reduction in repairs, the cited patent does not address the root cause of the damage but merely indicates palliative repairs that may be required again during the blade's lifespan.

If the replacement of isolated root components is not sufficient to address problems from the blade's design and manufacturing, one solution is to replace the entire original blade root assembly (2) with a redesigned one that incorporates targeted solutions for the underlying issues. In this case, the goal is to (1) manufacture a complete root assembly and (2) splice it onto the original blade, avoiding the need to condemn and fully replace the entire blade

Generally, the root of all blades is manufactured using layers of structural fiber fabric, e.g. fiberglass and carbon fiber, impregnated with resin such as epoxy and polyester. These layers are shaped like two semicircles, which are infused with resin on the halves of the shells and then bonded together to form the blade. This process may have minor variations: the root and shells can be impregnated simultaneously avoiding separate fabrication of the semicircles or the entire blade section (including the shells already joined together) can be manufactured at once.

Once the entire replacement blade root assembly (1) is fabricated, a strong connection between the assembly and the affected blade is essential. European Patent 2012790935 proposes that the blade root, whether new or not, is made from hollow cylinder segments that fit side by side, with the sides of each segment configured to match specific adjacent segments, thus avoiding errors. The patent further suggests that the complete assembly should have a circular crown shape at the end of the root that contacts the pitch bearing in the hub and should be longitudinally tapered. This forms bevels (3) to facilitate splicing new root to the remaining blade. However, no specific claims are made concerning the method of connecting the blade with the root, nor any other detail about the size of the proposed bevel.

Patents such as US20140178205A1 and U.S. Pat. No. 7,997,874B2 purely design mechanical unions between blade sections without specifically addressing the connection of the root assembly to the blade. U.S. Pat. No. 10,900,469B2 also proposes a mechanical union between a new blade tip and the rest of the component, which is feasible due to the relatively small stresses to which this blade region is subjected compared to the root.

This patent application describes a novel component for joining a root assembly to the hub to address the gap in root repairs using composite material manufacturing techniques, which provide greater reliability and mechanical strength compared to mechanical joints. Ideally, this assembly incorporates design improvements and has been manufactured following a stricter process or to greater quality standards than the original root assembly of a blade that has experienced damage or structural failures. This approach allows the continued use of a blade with a damaged root until the end of its useful life, avoiding the need for complete condemnation, disposal, and replacement of the blade. Such replacement blades are often unavailable in the market within a reasonable timeframe, leading to significant economic losses for wind farm operators. Even when available, these replacement blades come with higher associated costs compared to using the original blade with the reengineered root assembly. Additionally, this approach prevents the waste of new materials—both for manufacturing an entirely new blade and for producing replacement fastening components—and mitigates the negative ecological impact resulting from the disposal of condemned materials.

### SUMMARY OF THE INVENTION

The invention presented here describes a method for replacing a wind turbine blade root assembly. This method incorporates design improvements and adheres to more rigorous or controlled quality standards compared to the original root assembly of a blade that has experienced damage or structural failure. Furthermore, the system described by this invention allows the repaired blade to be used throughout its entire lifespan, avoiding premature disposal.

Therefore, the first presentation of the declared invention is a process for replacing a wind turbine blade root assembly. This method comprises the following steps:
Identification and cutting of the root section, containing the issue.
Design and manufacturing of a new root section.
Joining the new root using bevels.

In addition, we present a blade for wind turbines manufactured or repaired from the described method with at least one process of replacement of the root from the presented invention, as described in this document.

The drawings presented for the patent application are simplified representations of the components and assemblies mentioned throughout the description of the invention. They serve as illustrative examples, providing a basis for a complete understanding of the suggested method. The drawings depict the method's stages for only one of its possible applications, however, for other applications, an adaptation of the steps can be discerned from the drawings without any creative effort.

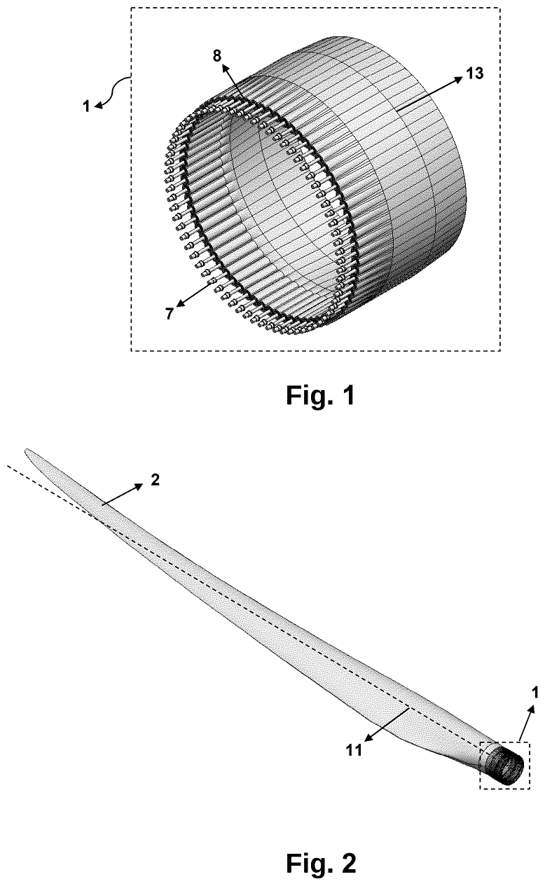

FIG. 1 shows the generalized complete root assembly, indicating the bevel line on the root assembly side (13), which is where the single bevel begins and extends into the end to be spliced into the blade.

FIG. 2 illustrates an original blade (2) with the complete root assembly (1) positioned for the joining process with the fiber fabrics and matrix. The longitudinal direction of the blade (11) is also shown.

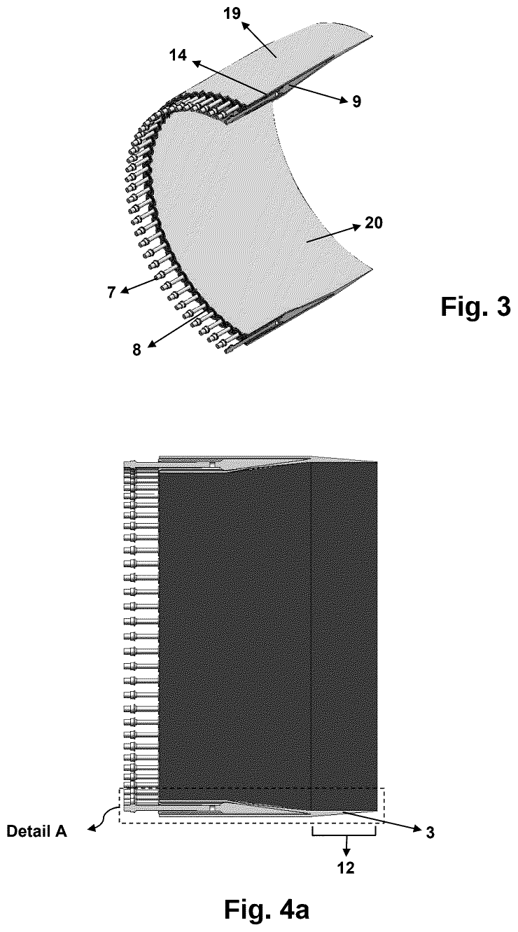

FIG. 3 shows a cut of the complete root assembly (1) in an isometric view, without the construction lines represented. It displays the fastening bolt (7), the contact face with the pitch bearing (8), and the insert extension (9).

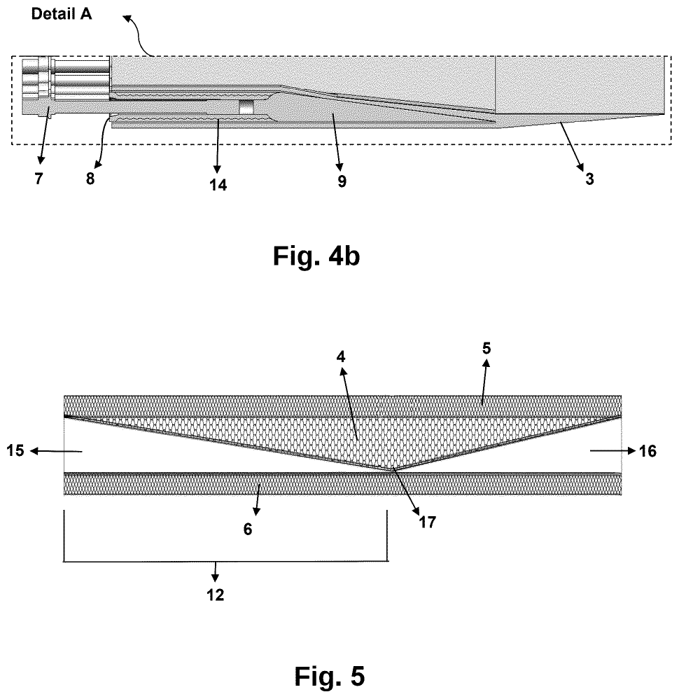

FIG. 4a presents the same cut as FIG. 3 but in a lateral view, indicating “Detail A,” which encompasses the blade fastening mechanism and shows its relative position to the bevel (3). The bevel length (12) is also shown.

FIG. 4b zooms in on “Detail A” from FIG. 4a. It highlights the fastening bolt (7), the contact face with the pitch bearing (8), the insert (14), the insert extension (14), and the generic single bevel (3).

FIG. 5 provides a detailed cut in the splice region. In this case, the bevel on the root assembly side (15) and the bevel on the original blade side (16) are joined by reconstruction layers (4), external reinforcement layers (5), and internal reinforcement layers (6). The function root (17), where the two bevels meet, is also indicated.

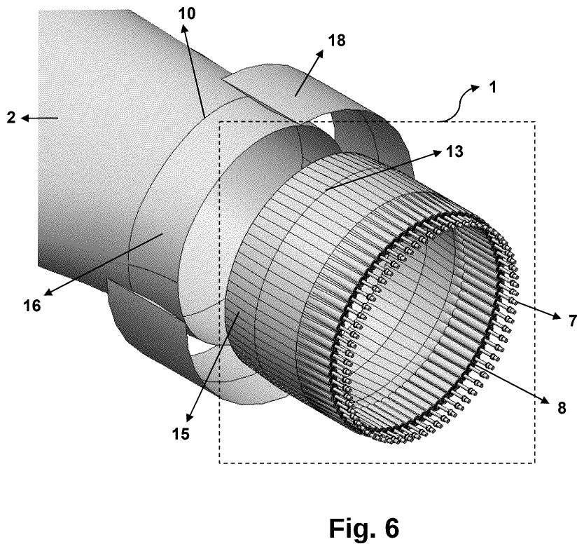

FIG. 6 illustrates the complete root assembly (1) ready to be joined with the original blade (2). Besides the fastening bolt (7) and the contact face with the pitch bearing (8), it shows the cross-sectional area of the blade without airfoils (10), the bevel line on the root assembly side (13), the bevel on the root assembly side (15), and the bevel on the original blade side (16). An exploded cut representation of the fiber fabric and matrix assembly for the splice (18) is also included.

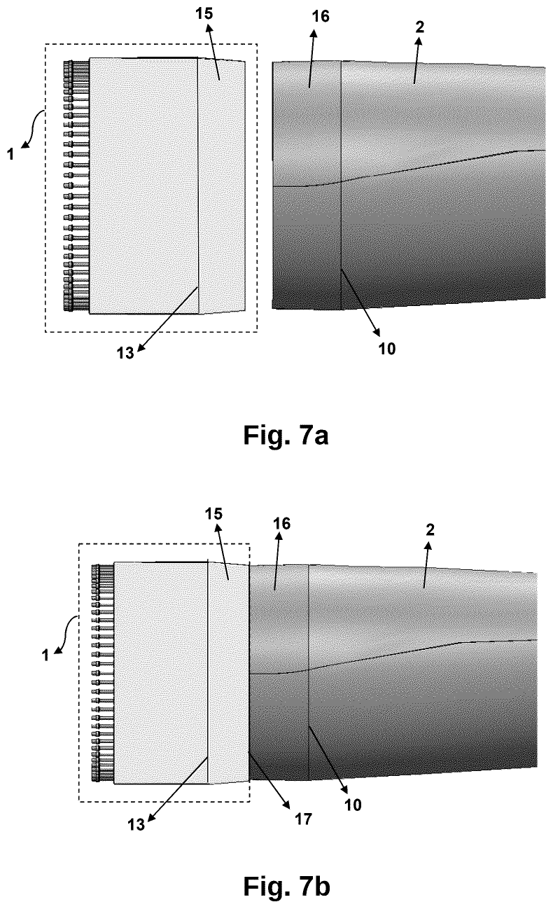

FIG. 7a depicts the complete root assembly (1) positioned for approximation to the cut original blade (2) in a lateral view. It also represents the cross-sectional area of the blade without airfoils (10), the bevel line on the root assembly side (13), the bevel on the root assembly side (15), and the bevel on the original blade side (16).

FIG. 7b depicts the same representation as FIG. 7a, but now with the complete root assembly (1) fully aligned with the original blade (2) at the joint root region (17). The addition of fiber fabric layers and matrix material for the splice remains to be done.

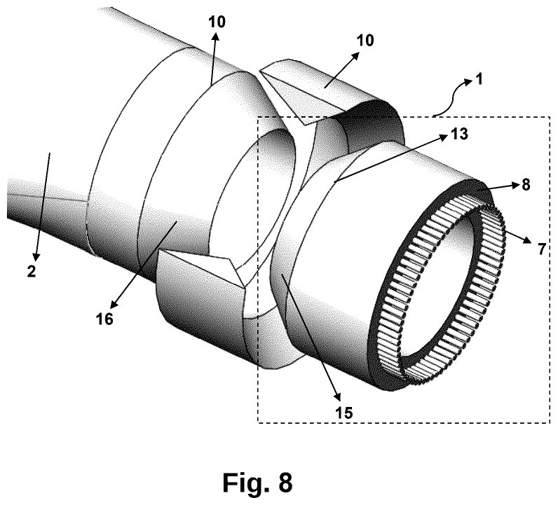

FIG. 8 illustrates the same view of FIG. 6, but with exaggerated dimensions for the original blade thickness (2), the complete root assembly thickness (1), to the bevel length (12), and to its angle, and the measurements of the fiber fabric and matrix assembly for the splice.

### DETAILED DESCRIPTION OF THE INVENTION

The examples shown serve to demonstrate one of many ways of implementing this invention, while not limiting its scope.

The conceived solution broadly involves the complete cutting of the root section containing the problem, redesigning and manufacturing a new root section, followed by the process of joining the new root to the blade using single or double bevels (3) at any bevel angle. This applies to both the generalized complete root assembly (1), as shown in FIG. 1, and the cut and preparation of the original blade (2), represented in FIG. 2 by a generic wind turbine blade. The actual invention described in this patent application lies in this joining process, which also includes the decision on where to cut the original blade (2) to accommodate the new complete root assembly (1), a consequence of the chosen bevel type (3) for the repair.

The novel method proposed here is not limited to a single type of wind turbine blade; it can be used in any model that employs composite materials in its structural composition. There are no limitations regarding the dimensions of the blade that can receive the described repair, nor are there any restrictions on the intended application of the blade concerning environmental operating conditions and loading scenarios described in technical standards. These considerations apply as long as they were taken into account during the design of the blade and the new root assembly.

Before defining the longitudinal cutting position for the blade that has suffered root damage, it is necessary to determine the type of bevel (3) to be used in the corrective action. Either a single bevel or a double bevel can be adopted, both in the new, complete root assembly (1) and in the original blade (2). The choice may result from various factors, such as what is practically required for field repair, in which case the single bevel is easier due to its simplicity. If opting for the single bevel, it is also necessary to choose the surface on which it will be made, which can be either the external surface (19) or the internal surface (20) of the original blade (2), as shown in FIG. 3. The first option is also more suitable for fieldwork execution.

Once the type of bevel (3) is selected, calculating the bevel length (12), and consequently its angle, has different constraints depending on the available dimension range for each raw piece. For the complete root assembly (1), the length can extend from the free end to be spliced into the blade, which coincides with the joint root (17), up to the position where there is no interference with the innermost components of the assemblies that make up the blade fasteners—referred to here as the bevel line on the root assembly side (13), as seen in FIG. 1. These components may include special nuts, the insert extension (9) anchoring the bolt, or any other designated fastening mechanism. For the original blade side (2), the bevel length (12) should preferably, but not exclusively, be limited to the cross-sectional area of the blade without airfoils (10) or where it minimally interferes with other structural components of the blade, as best exemplified in FIG. 4a and FIG. 4b.

Once the above-mentioned dimensional parameters are established, the type and quantity of material necessary to be incorporated into the repair must be determined through structural analyses. Considerations include factors such as the weight to be added to the structure, response to anticipated loads from structural calculations, and the degree of interference caused by the bevel cut in the original blade structure. From these analyses, the choice of repair layers also emerges. In addition to the reconstruction layer (4) external (5) and/or internal (6) reinforcement layers can be accommodated, characterized by the fiber fabrics and matrix material to be deposited within the bevel length interval. These reinforcement layers always rest upon the reconstruction layers (4), and there are no limitations on their extension along the longitudinal direction of the blade (11). Therefore, the choice of this length depends on the specific characteristics of each repair performed. FIG. 5 provides a representation of the arrangement of these layers and illustrates the bevel on the root assembly side (15) and the bevel on the original blade side (16).

Regarding the dispersed phase of the composite materials used, there are no restrictions based on criteria such as concentration, size, shape, distribution, or fiber orientation. Particularly, the fiber fabric employed in any layer, whether uniaxial or multiaxial, should be chosen based on the unique solution for each blade, regardless of whether it corresponds to the orientation of the fiber fabric used in the original blade (2). The same approach applies to the other criteria mentioned previously, extending to external (5) and internal (6) reinforcement layers, if present.

After stacking the reconstruction fabric layers (4), there are two possibilities: if reinforcement layers are to be used, they should be added over the reconstruction layers (4). Then, a combined process of impregnation with the material constituting the matrix phase—preferably plastic resins—is initiated with subsequent stacking of the reinforcement layers and is repeated for either the external (19) or internal surface (20) of the blade (FIG. 5). Regarding the adopted lamination processes, there are no type restrictions, although vacuum infusion is commonly preferable due to better control over the process and final quality. However, manual lamination methods (such as hand layup) can also be employed and variations in vacuum infusion strategies for resin addition are possible e.g. resin can be introduced into the vacuum bag through multiple points.

Additionally, the present invention presents a grain trailer comprising at least one tarping and untarping system for the bodies, as described above.

Those involved in the engineering and maintenance of wind turbines will appreciate and reproduce this novel process as described and in its many possible variations within the scope of this document.

1. A wind turbine blade root replacement method comprising the following steps:
identification and cutting of the section of the root that contains damage;
projection and manufacturing of a new section of root;
splicing new root by bevels;
using bevels on both the root assembly side and the original blade side to be repaired by joining them in the joint root region and spliced using a combination of fiber fabric and matrix material.

2. The method of claim 1, comprising employing either single or double bevels, both for the root assembly side and the original blade side.

3. The method of claim 1, comprising allowing any bevel length and, consequently, any bevel angle to be repaired and the new complete root assembly to be spliced into the blade.

4. The method of claim 1, comprising permitting the axial positioning of the bevel, for both the root assembly and the original blade, with each position determined based on unique analyses for each type of blade to be repaired.

5. The method of claim 1, comprising utilizing any specific cutting method and any surface preparation method for beveling, both for the root assembly and the original blade.

6. The method of claim 1, comprising joining the complete root assembly to the original blade using any lamination method.

7. The method of claim 1, comprising using reconstruction layers to level the thickness at the splice between the complete root assembly and the original blade.

8. The method of claim 1, comprising allowing the use of any fiber fabric and matrix material for laminating the reconstruction layer, encompassing various possibilities regarding fabric configuration in terms of concentration, size, shape, distribution, and fiber orientation.

9. The method of claim 1, comprising using external reinforcement layers (5) and internal reinforcement layers, where “external” and “internal” refer, respectively, to the external and internal surfaces of the original blade.

10. The method of claim 1, comprising permitting the use of any fiber fabric and matrix material for laminating the reinforcement layers, considering various possibilities regarding fabric configuration in terms of concentration, size, shape, distribution, and fiber orientation.

11. The method of claim 1, comprising which alternatively dispenses with the use of external and internal reinforcement layers for splicing the complete root assembly to the original blade,

12. The method of claim 1, comprising being applicable to all types of wind turbine blades, regardless of specific environmental operating conditions and specific loading scenarios.
